(19) United States
(12) Patent Application Publication
(10) Pub. No.: US 2022/0398794 A1
(43) Pub. Date: Dec. 15, 2022

(54) ARTIFICIAL INTELLIGENCE (AI) LIFELIKE 3D CONVERSATIONAL CHATBOT

(71) Applicant: Vizzio Technologies Pte Ltd, Singapore (SG)

(72) Inventor: Seng Fook LEE, Singapore (SG)

(21) Appl. No.: 17/837,067

(22) Filed: Jun. 10, 2022

Related U.S. Application Data
(63) Continuation-in-part of application No. 17/752,883, filed on May 25, 2022.
(60) Provisional application No. 63/208,984, filed on Jun. 10, 2021.
(60) Provisional application No. 63/208,985, filed on Jun. 10, 2021.

(51) Int. Cl. G06T 13/20; G06T 13/40; G06F 40/40; G06F 40/35; G10L 15/22; G10L 15/26; G10L 13/02; G06V 20/40; G06V 40/20; H04L 51/02

(52) U.S. Cl. CPC G06T 13/205; G06T 13/40; G06F 40/40; G06F 40/35; G10L 15/22; G10L 15/26; G10L 13/02; G06V 20/41; G06V 40/20; H04L 51/02

(57) ABSTRACT

A 3D conversational chatbot is disclosed. The conversational chatbot is embodied in an avatar to provide a human-like experience for end-users. The chatbot is an artificial intelligence-based chatbot. The chatbot is configured with the knowledge of the chatbot owner. The knowledge may depend on the owner, such as the products and/or services provided by the owner. For example, the chatbot is customized with AI for the specific needs of its owner. The avatar communicates with the user, such as a customer, to answer questions with life-like speech and facial movement.

### CROSS-REFERENCE

This application is a continuation-in-part of the US Patent Application filed on May 25, 2022, with application Ser. No. 17/752,883, titled HIGHLY PARALLEL VIRTUALIZED GRAPHICS PROCESSORS. This application also claims the benefit of US Provisional Applications with Ser. Nos. 63/208,984, and 63/208,985 which were all filed on Jun. 10, 2021. All disclosures are herein incorporated by reference in their entireties for all purposes.

### FIELD OF THE DISCLOSURE

The present disclosure relates to 3D AI life-like conversational chatbots.

### BACKGROUND

Conversational chatbots are widely used for different types of service applications, such as customer service applications, sales applications, marketing applications, human resource applications, as well as many others. The use of conversation chatbots enables an end-user to obtain information without the need for a human interface. For example, conversational chatbots enable a company to provide 24-7 service to end-users without the need to staff a service department without humans. As such, conversational chatbots reduce cost as well as improve operational efficiency.

To improve performance, artificial intelligence (AI) has been incorporated into conversational chatbot applications. However, even though performance is improved, conversational chatbots are text-based, audio-based or both. As such, conventional conversational chatbots fail to produce human-like interactions with end-users. For example, there is no human-like interface with the end-users.

The present disclosure is directed to life-like 3D conversational chatbots to provide a human-like experience for end-users.

### SUMMARY

An embodiment of the disclosure relates to a chatbot system. The chatbot system includes a multi-modal conversational (MMC) module configured to process user input into a processed input for the chatbot system to respond. The chatbot system also includes a database module. The database module contains information related to an owner of the chatbot system, wherein the database module is configured to generated a text response based on the processed user input, wherein the MMC module converts the text response to an audio response. The chatbot system also includes an audio to face module, an avatar animation module and an avatar generation module, wherein the avatar generation module is configured to cooperate with the audio to face module and the avatar animation module to generate an animated 3D lifelike avatar speaking the audio response with facial movement.

Another embodiment of the disclosure relates to a method for communicating with a chatbot. The communication includes providing user input to a chatbot system, processing the user input to generate a processed input, generating the text response to the processed input using a database module containing information related to an owner of the chatbot system, converting the text response to an audio response and generating an animated lifelike 3D avatar speaking the audio response with facial movement.

These and other advantages and features of the embodiments herein disclosed, will be come apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

FIG. 1 shows a simplified AI-based 3D conversational chatbot platform;

FIG. 2 shows a simplified AI 3D conversational chatbot system; and

FIG. 3 depicts an embodiment of a chatbot system.

### DETAILED DESCRIPTION

Embodiments described herein generally relate to a platform or application (App) for AI 3D conversational chatbot. The AI 3D chatbot is, for example, a life-like 3D avatar configured to carry on a conversation with, for example, a person (end-user or user).

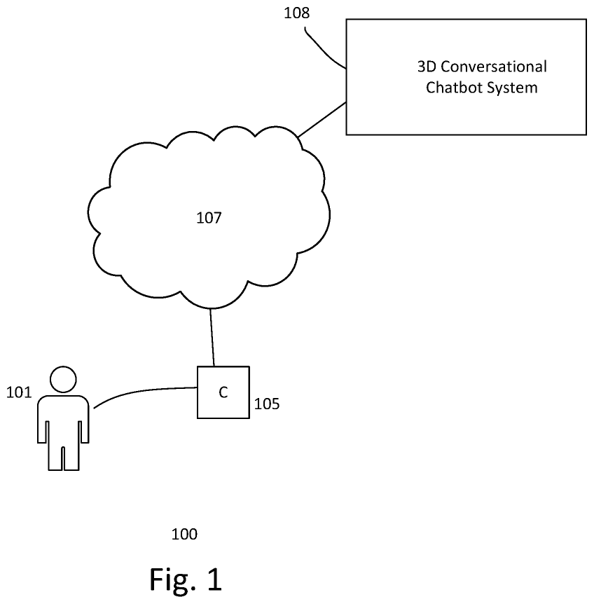

FIG. 1 shows a simplified embodiment of an AI-based conversational chatbot platform 100. As shown, the platform includes a 3D conversational chatbot system 108. The 3D conversational chatbot system, for example, may belong to a chatbot owner, such as a service provider. The service provider, for example, may be a merchant providing a service or selling goods. The 3D conversational chatbot system, for example, may serve as a human-less customer service representative of the chatbot owner. Other purposes for the conversational chatbot system may also be useful. The chatbot is an AI-based chatbot that can communicate like a human. For example, the chatbot is configured with facial movements and lifelike voices, making it a life-like chatbot.

The chatbot system is connected to a communication network 107. The communication network, for example, maybe the internet. Other types of communication networks may also be useful. A user 101 may access the 3D conversational chatbot system through his/her user device 105 via the internet (wired or wirelessly). For example, the user device may be connected to the internet through a router or connection point of an internet service provider. Other types of communication networks may also be useful.

The conversational chatbot system may be a cloud-based system. For example, the system may be hosted on a cloud service. Alternatively, the system may be hosted on the server of the system owner, such as the merchant. The system may be a web-based system. For example, a user may access the system through a browser. By entering the universal resource locator (URL) or web address of the owner, the browser is directed to the chatbot system. Other types of systems, such as client-server systems, may also be useful. For example, a front-end application (App) may be installed on a user device while the back-end system may reside on a server. By initiating the App, the backend chatbot system may be accessed.

Once accessed, the App displays a 3D avatar of the chatbot system on the user device's display. A baseline avatar model may be selected or developed by the owner of the chatbot system to be the chatbot. For example, the characteristics of the avatar model may be chosen by the system's owner. The avatar model may be developed using an avatar generator application. Other techniques for generating the avatar model may also be useful.

The avatar may greet the user and ask the user what is needed. As discussed, one of the uses for the chatbot system is a human-less customer service representative. For example, when a user, such as a customer, accesses the chatbot system, questions may be asked of the chatbot. The questions may relate to a product or service offered by the chatbot owner. Other types of questions may also be asked. For example, questions may relate to the status of an order by the customer. A question may be presented by the user using video and voice input, voice input or text input. Presenting questions during a session using different inputs or a combination of inputs may also be useful.

The system processes the question and responds accordingly. For example, in the case of voice input, processing may include speech to text conversion, natural language processing for understanding the question, including context and text to speech conversion of the response for speaking by the avatar. During a session, a series of questions may be asked and the system responds accordingly. In one embodiment, the 3D avatar is imparted with lifelike characteristics, including facial expressions and voice, such as facial, eye and mouth movements as well as natural speech corresponding to the response.

In one embodiment, the system includes an intelligent software module for upgrading and improving the performance and accuracy of the chatbot. The intelligent software or system module, for example, may be referred to as an assessment unit or assessment module. The assessment unit may be part of the chatbot's AI. Other configurations of the assessment unit may also be useful. In the case of video input, the assessment unit can analyze the video of the user to determine the satisfaction factor of the session. The satisfaction factor may be based on emotional indicators of the user, such as facial expressions, hand gestures and speech, such as loudness, speed and intonation. The emotional indicators can be analyzed to infer the satisfaction factor of the user, such as contentment, happiness, frustration, uncertainty and anger. In the case of text input, emotional indicators can be inferred from the text input. For example, words of dissatisfaction or satisfaction can be discerned from the text input from the user. From the analysis of the assessment unit, the chatbot can understand misunderstandings in the user's question, learning from the misunderstandings and mistakes to improve the chatbot's performance.

In some embodiments, the system may include different avatars. Providing the system with different avatars may be advantageous, such as providing diversity in the characteristics or appearance. In general, a user may be communicating with a specific avatar model throughout a session. This may be useful to provide consistency during the session. The specific avatar model chosen for a session may be random. In other cases, the specific avatar model chosen may depend on the customer. For instance, a user may have a high satisfaction factor with a specific avatar model. In such a case, the system may assign the avatar model for the specific customer. Other configurations of the avatar models may also be useful.

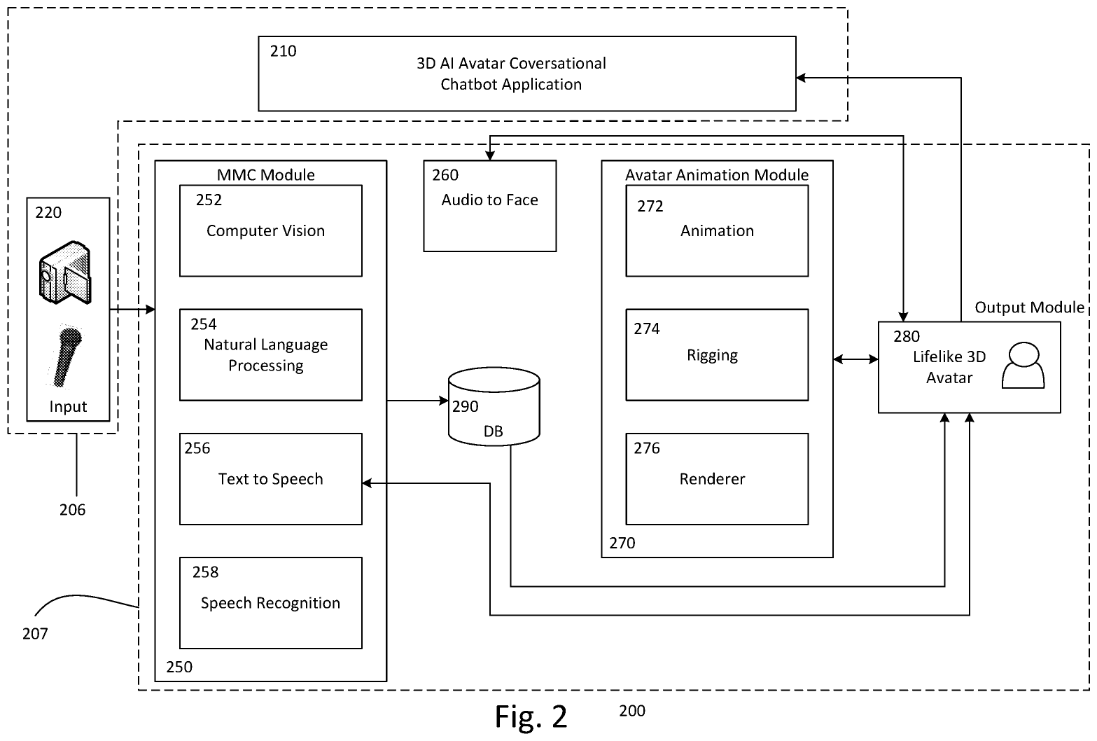

FIG. 2 shows a simplified embodiment of an AI 3D conversational chatbot system 200. The system, for example, may be implemented as a software application (App). The App may be a cloud-based App or a client-server App. The App, for example, may be a native App, a web-based App or a client-server App. Other configurations of the App may also be useful. The App may include a frontend portion 206 running on a user device and a backend portion 207 running on the cloud or server. Other configurations of the App may also be useful.

The system, in one embodiment, includes a chatbot module 210, an input module 220, a multimode conversational (MMC) module 250, a database (DB) module 290, an audio-to-face module 260, an avatar animation module 270, an avatar output module 280 and a database module 290. Providing the platform with other modules may also be useful.

In one embodiment, the frontend portion or subsystem includes the chatbot and input modules. For example, the frontend portion controls the user device to enable a user to provide input to the system via the input module of the user device. The response to the input is provided by the chatbot, for example, on the display of the user device. As for the MMC, audio to face, DB module, avatar animation and output modules, they are part of the backend subsystem. The backend subsystem processes the input and generates a response for the avatar to convey to the user via the frontend subsystem.

In one embodiment, the input module may include a camera and a microphone to enable the user to provide audio/video (A/V) input to the system. The input module is configured to capture the A/V inputs of the user when speaking to the 3D AI avatar chatbot. Speaking to the 3D AI avatar chatbot may be similar to participating in a video conference using, for example, a user device configured with a camera and microphone. For example, a user may speak into the user device configured with a camera and microphone and a display displaying the 3D AI avatar chatbot conversing with the user. Providing the input module with other input devices may also be useful. For example, the input module may include a keyboard, such as a physical or soft keyboard, or other types of input devices. The keyboard may be employed to provide text input. Input may collectively refer to any kind of input, such as A/V, audio or text.

The input, for example, is provided to the backend system for processing. In one embodiment, the input is processed by the MMC module. As shown, the MMC module includes a computer vision unit 252, a natural language processing (NLP) unit 254, a text to speech (TTS) unit 256 and a speech recognition unit 258. Providing other units for the MMC module may also be useful.

The MMC processes the input from the user. The MMC module employs artificial intelligence (AI) to process the input and generate a response for the avatar to convey to the user. In one embodiment, the input is in text form or converted to text form from audio. The text input is then processed by the NLP unit. For example, the NLP unit processes the text input using natural language processing to understand what the user is asking. In one embodiment, the NLP unit employs a Generative Pre-trained Transformer 3 (GTP-3) NLP unit. The GTP-3 NLP unit is an autoregressive language model that uses deep learning to produce human-like text.

Based on the processed input text (processed input), a response is generated. In one embodiment, the system retrieves the response from the DB module based on the processed input. The DB module 290 stores the knowledge base of the owner of the chatbot system. For example, the DB module stores the knowledge for the AI avatar. In other words, the database module serves as the brain of the AI avatar. The information stored in the database may depend on the owner, such as the products or services provided by the owner. The database, in one embodiment, may employ deep learning for training on a data set to generate answers and knowledge relevant to the owner. The MMC, for example, understands the context of the user input and searches the database module for the correct response to the user input.

As an example, in the case that the owner is an online automobile parts supplier, the DB module will contain information of all the parts supplied by the owner. For example, parts information may include part number, part name, vehicle applicability and price. In addition, the DB may include customer information, existing order information as well as other relevant information of the owner's business. Customer information, for example, may include name, address, phone number, and customer's vehicle information while existing order information, for example, may include customer name, parts ordered, total costs, expecting shipping and/or delivery date.

The response obtained from the DB module, in one embodiment, is in text form (text response). The text response is provided to the avatar output module. The avatar output module, in one embodiment, cooperates with the audio to face module, the avatar animation module and the text to speech unit of the MMC to produce a lifelike 3D avatar to speak the response on the display of the user device.

In one embodiment, the avatar animation module includes an animation unit 272, a rigging unit 274 and a rendering unit 276. The response is provided to the avatar animation module, the audio to face module and the text to speech unit. In one embodiment, the response is provided to the avatar animation module, the audio to face module and the text to speech unit by the avatar output module. Other configurations of providing the response to the various modules may also be useful.

The various units of the avatar animation module, the audio to face module and text to speech unit are configured to animate the 3D model of the virtual human which includes the animated face with the voice from the audio to face module and the text to speech. Various animation, rigging, rendering units, audio to face modules and text to speech units may be employed. The various modules generate an animated 3D avatar. For example, the 3D avatar is a lifelike 3D avatar with body movements, including facial expressions as well as a human-like voice. The animated 3D avatar is passed to the front-end chatbot App for displaying on the display of the user device. For example, a digitized animated 3D avatar is transmitted via the communication network to the front-end chatbot App running on the user device. The system may repeatedly process additional questions by the user and process the questions to generate responses by the animated 3D avatar.

In one embodiment, the system includes an assessment unit (not shown). The assessment unit, for example, may be incorporated as part of the MMC unit. Providing the assessment unit as part of a separate module or other modules of the backend subsystem may also be useful.

The assessment unit is configured to assess the input to determine the satisfaction factor of the session. For example, based on a range, such as 1 to 5 where 5 represents very satisfied and 1 represents very dissatisfied. A satisfaction threshold satisfaction factor can be set to trigger an analysis to understand why the user was dissatisfied and to correct the AI to improve avatar performance.

In the case of video input, the assessment unit can be part of the computer vision unit for analyzing the video of the user to determine the satisfaction factor of the session. The satisfaction factor may be based on emotional indicators of the user, such as facial expressions, hand gestures and speech, such as loudness, speed and intonation. The emotional indicators can be analyzed to infer the satisfaction factor of the user, such as contentment, happiness, frustration, uncertainty and anger. In the case of text input, emotional indicators can be inferred from the text input. For example, words of dissatisfaction or satisfaction can be discerned from the text input from the user.

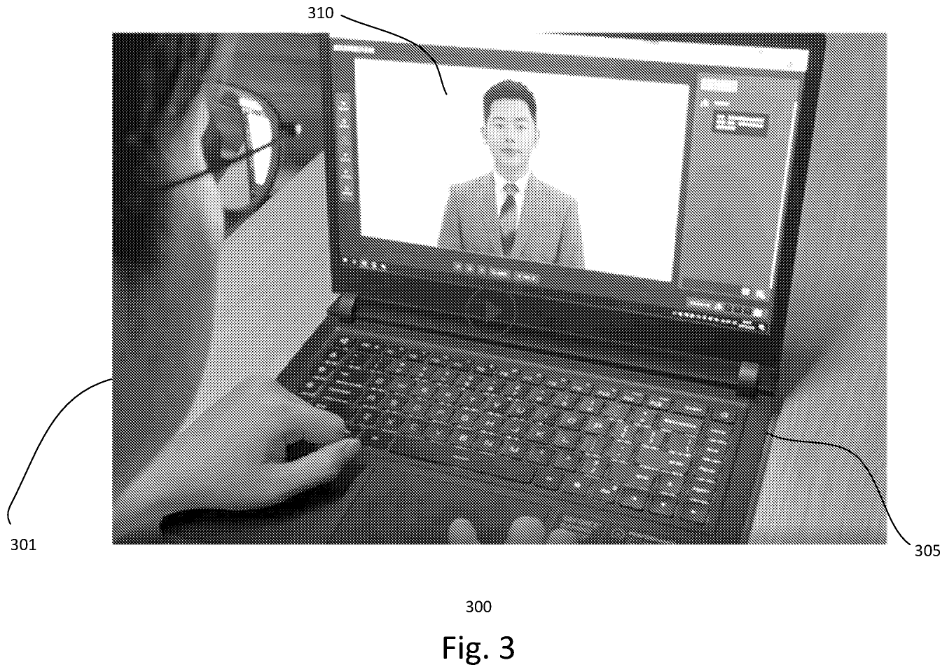

FIG. 3 depicts an embodiment of a chatbot system 300. As shown, a user 301 accesses the chatbot system using a user device 305, such as a laptop computer. When accessed, the avatar 310 of the chatbot system is displayed on the display of the user device. The user may communicate with the chatbot system using the various components of the user device, such as the camera, microphone, keyboard or a combination thereof.

The inventive concept of the present disclosure may be embodied in other specific forms without departing from the spirit or essential characteristics thereof. The foregoing embodiments, therefore, are to be considered in all respects illustrative rather than limiting the invention described herein.

1. A chatbot system comprising:
a multi-modal conversational (MMC) module, the MMC module is configured to process user input into a processed input to for the chatbot system to respond;
a database module, the database module contains information related to an owner of the chatbot system, wherein the database module is configured to generate a text response based on the processed user input, wherein the MMC module converts the text response to an audio response;
an audio to face module;
an avatar animation module; and
an avatar generation module, wherein the avatar generation module is configured to cooperate with the audio to face module and the avatar animation module to generate an animated 3D lifelike avatar speaking the audio response with facial movement.

2. The chatbot system of claim 1 wherein the MMC module comprises:
a speech recognition unit the speech recognition unit, when the user input is an audio input, is configured to covert the audio input to a text input;
a text to speech unit, wherein the text to speech unit is configured convert the text response to the audio response; and
a natural language processing (NLP) unit for processing the text input into the processed input for the database module to generate the text response.

3. The chatbot system of claim 2 wherein the text to speech unit is configured to generate human-like speech for the audio response.

4. The chatbot system of claim 1 wherein the user input comprises a text input, the text input is processed by a natural language processing unit to generate the processed input.

5. The chatbot system of claim 1 wherein the database module comprises deep learning for training on a data set to generate the information relevant to the owner.

6. The chatbot system of claim 5 wherein the information contained in the database module comprises answers and knowledge information relevant to the owner.

7. The avatar chatbot system of claim 1 wherein avatar animation module comprises:
an animation unit;
a rigging unit; and
a renderer unit;
wherein the animation unit, the rigging unit and renderer unit cooperate with the audio to face module to generate the animated an animated 3D lifelike avatar speaking the audio response with facial movement. 3D lifelike avatar speaking the audio response with facial movement.

8. The chatbot system of claim 1 wherein the chatbot system comprises:
a backend portion, wherein the backend portion comprises the MMC module, the database module, the audio to face module, the avatar animation module and the avatar generation module, the backend portion is configured to run on a server; and
a frontend portion, the frontend portion comprises a frontend 3D conversational chatbot application configured to run on a user device.

9. The chatbot system of claim 8 wherein the backend portion is configured to transmit the animated 3D lifelike avatar speaking the audio response with facial movement to the frontend portion for displaying on the user device.

10. The chatbot system of claim 1 wherein the MMC module comprises a computer vision unit, wherein the computer vision unit, the computer vision unit is configured to analyze a video input of the user to determine a satisfactory factor.

11. A method for communicating with a chatbot comprising:
providing user input to a chatbot system;
processing the user input to generate a processed input;
generating the text response to the processed input using a database module containing information related to an owner of the chatbot system;
converting the text response to an audio response; and
generating an animated lifelike 3D avatar speaking the audio response with facial movement.

12. The method of claim 11 comprises transmitting the animated lifelike 3D avatar to a frontend portion for display on a user device.
